(19) United States
(12) Patent Application Publication
(10) Pub. No.: US 2007/0290062 A1
(43) Pub. Date: Dec. 20, 2007

(54) Aerosol generating apparatuses and methods for aerosolizing chemicals

(76) Inventors: John M. Forsythe, Nampa, ID (US); Jan W. de Weerd, Meridian, ID (US); Curtis Lee Eames, Meridian, ID (US); Henry J. Duncan, Glasgow (GB)

Correspondence Address: TRASK BRITT, P.O. BOX 2550, SALT LAKE CITY, UT, 84110, US

(21) Appl. No.: 11/807,357

(22) Filed: May 24, 2007

Related U.S. Application Data
(60) Provisional application No. 60/802,919, filed on May 24, 2006.

(51) Int. Cl. A23B 7/144; B05B 1/24; B05B 7/16

(52) U.S. Cl. 239/8; 239/135

(57) ABSTRACT

Thermal foggers may include two or more feed inlets for introducing multiple feed streams to a thermal fogger aerosol generation zone such that the feeds may be introduced at different temperatures. Alternatives also include thermal foggers having multiple barrels such that different chemicals may be aerosolized in different aerosol generation zones to produce multiple aerosols which may be combined and applied to agricultural products, produce, or other surfaces or volumes, and thermal foggers including inlets for injecting non-combustible gases or liquids.

### CROSS-REFERENCE TO RELATED APPLICATION

This application claims the benefit of U.S. Provisional Application No. 60/802,919, filed May 24, 2006.

### BACKGROUND OF THE INVENTION

1. Field of the Invention

The invention relates to devices and methods for producing aerosols from one or more chemicals. More particularly, the invention relates to aerosol generating devices capable of aerosolizing two or more composition feed streams conjointly or sequentially for application to a surface.

2. State of the Art

Thermal foggers or aerosol generation devices have been used to generate aerosols of chemicals which can be applied to agricultural products or produce such as tubers, potatoes, and fruit. Thermal generation devices generally produce a single chemical aerosol from a chemical feed inlet into an aerosol generation zone of the thermal fogger. Often times, the single feed inlet is not positioned in an ideal position within the thermal fogger to produce an aerosol at a desired temperature. In addition, the production of a single aerosol requires that multiple applications, i.e. multiple thermal fogging runs, are required to apply more than one chemical aerosol to a desired target.

Thermal foggers currently being utilized to generate aerosols from chemicals, and especially for chemicals used to apply aerosols to harvested fruits and vegetables, include thermal foggers such as Leco machines and more advanced thermal foggers as disclosed in U.S. Pat. No. 6,322,002, entitled “Aerosol Generating Device” and issued to Forsythe et al. on Nov. 27, 2001, the disclosure of which is incorporated by reference herein in its entirety. Another thermal aerosol generating device is disclosed in U.S. Pat. No. 4,226,179, entitled “Apparatus For Applying Sprout Inhibitor” and issued to Sheldon et al. on Oct. 7, 1980, the disclosure of which is incorporated by reference herein in its entirety.

Therefore, it is desirable to develop methods and devices for applying multiple chemical aerosols from a single thermal fogger device. It is also desirable to provide methods whereby the aerosolizing temperature for each chemical introduced to the thermal fogger may be controlled. Such control may improve output and provide aerosols that are optimized based upon the chemicals being applied aerosolized by the thermal fogger.

### SUMMARY OF THE INVENTION

According to embodiments of the invention, a thermal fogger or aerosol generation device may include more than one feed inlet such that one or more feed streams may be introduced simultaneously, overlapping, or sequentially into a thermal fogger for aerosol generation in a controlled manner. The thermal foggers according to embodiments of the invention may be configured to produce aerosols from feed streams at different temperatures based upon the location of the feed inlets in the thermal fogger. Preferred aerosolizing temperatures may vary depending upon the particular chemical being aerosolized.

According to some embodiments of the invention, an aerosol generation zone within a thermal fogger includes two or more feed inlets, wherein the feed inlets are positioned at different locations within an aerosol generation zone to provide a desired temperature for aerosolizing a chemical introduced through the separate feed inlets. For example, a first feed inlet may be positioned in a portion of the aerosol generation zone which is hotter than the location of a second feed inlet, which may be positioned downstream from the first inlet, such that a chemical introduced through the first feed inlet is aerosolized at a higher temperature than a chemical introduced at the second feed inlet.

According to other embodiments of the invention, a thermal fogger may include two or more barrels, each barrel having a combustion zone and an aerosol generation zone. The temperatures within each of the two or more barrels may be controlled such that the temperatures within the aerosol generation zones can be the same or different. Chemicals introduced through the two or more barrels may be aerosolized at a desired temperature and combined to produce an aerosol product having a desired chemical composition.

In still other embodiments of the invention, aerosols may be applied to agricultural crops or produce using thermal aerosol generation whereby a first chemical may be introduced to a first aerosol generation zone at a first temperature and a second chemical may be introduced to a second aerosol generation zone at a second temperature. The first and second chemicals may be introduced into the same aerosol generation zones or into different aerosol generation zones. The temperatures within the aerosol generation zones, or at the positions of introduction of the chemicals into a single aerosol generation zone, may be controlled to aerosolize the first and second chemicals at different temperatures. The first and second temperatures may differ by any amount, and may preferably differ by about 25° F. or more.

According to other embodiments of the invention, potatoes, such as potatoes in a storage facility, may be treated with two or more chemicals simultaneously using thermal foggers according to embodiments of the invention. One or more chemicals may be aerosolized by a thermal fogger having multiple barrels and/or a single barrel with multiple feed inlets such that a desired aerosolized chemical composition may be directed from a thermal fogger to a potato storage facility. For example, CIPC and DMN, CIPC and clove oil, CIPC and higher alcohols, or DMN and clove oil aerosols may be simultaneously applied to a tuber or potato storage facility using a thermal fogger according to embodiments of the invention. The CIPC aerosol generation temperature may be different, typically higher, than the aerosol generation temperature of any of the other chemicals, and where DMN can be applied at a temperature higher than clove oil and generally at about the same or higher temperature than higher alcohols. Other chemicals may be substituted for the recited chemicals in various combinations.

### BRIEF DESCRIPTION OF THE DRAWINGS

While the specification concludes with claims particularly pointing out and distinctly claiming that which is regarded as the present invention, this invention can be more readily understood and appreciated by one of ordinary skill in the art from the following description of the invention when read in conjunction with the accompanying drawings in which:

FIG. 1 illustrates a thermal fogger according to embodiments of the invention;

FIG. 2 illustrates a thermal fogger according to embodiments of the invention; and

FIG. 3 illustrates a thermal fogger according to embodiments of the invention.

### DETAILED DESCRIPTION OF THE ILLUSTRATED EMBODIMENTS

According to particular embodiments of the invention, a novel aerosol generator, or thermal fogger, is provided. While particular embodiments of the invention may be referred to as aerosol generators, it is understood that the recitations “thermal logger” are occasionally used to describe aerosol generators and the use of the recitations “aerosol generator” and “thermal fogger” are considered equivalents with respect to embodiments of the invention. A “thermal fogger” may also include a hot air generator.

According to embodiments of the invention, a combustion-type aerosol generator, or thermal fogger, may be adapted to include two or more inlets for accepting and communicating one or more feed streams into an aerosol generator to produce an aerosol therefrom. In other embodiments of the invention, a thermal fogger may include two or more barrels spatially configured to provide two or more aerosolized products to one or more surfaces. In still other embodiments of the invention, a thermal fogger having two or more inlets may include one or more control systems for controlling the amounts of feed streams which are aerosolized by the thermal fogger such that the composition of the aerosol produced by the thermal fogger may be controlled.

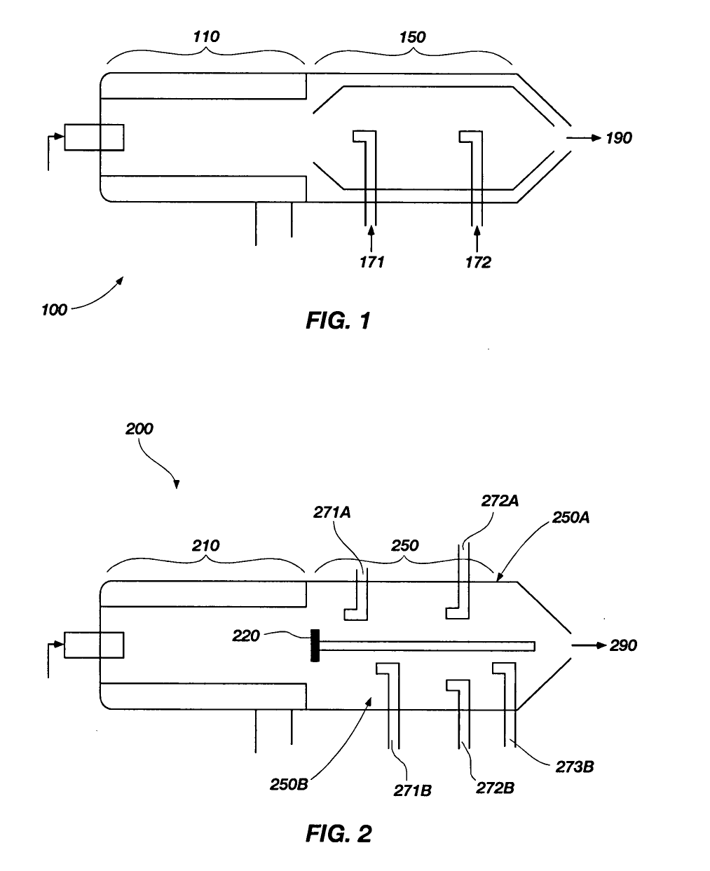

According to some embodiments of the invention a thermal fogger may include two or more inlets for accepting chemical feed streams to be aerosolized. A thermal fogger according to particular embodiments of the invention is illustrated in FIG. 1. The thermal fogger 100 may include a combustion zone 110 and an aerosol generating zone 150. A first feed inlet 171 may be positioned and configured to deliver a first feed stream into the aerosol generating zone 150. A second feed inlet 172 may be positioned and configured to deliver a second feed stream into the aerosol generating zone 150 at a different location from the first feed inlet 171. Inlet feed streams which are fed to the aerosol generating zone 150 may be aerosolized within the aerosol generating zone 150 in the same manner that feed streams introduced to an aerosol generating zone of a conventional thermal fogger are aerosolized. An aerosol product 190 produced by the thermal fogger 100 exits the thermal fogger 100 and may be applied to a surface or distributed into a volumetric space. For example, an aerosol product 190 may be directed into a potato storage facility where the aerosol product 190 may be distributed onto the surfaces of potatoes stored in the facility. The aerosol product may contain separate, minute droplets or particles of each chemical although the aerosol product may be a combination of chemicals.

While two feed inlets—first feed inlet 171 and second feed inlet 172—are illustrated in FIG. 1, it is understood that particular embodiments of the invention may include a plurality of feed inlets such that two or more feed streams may be introduced into the aerosol generating zone 150 of a thermal fogger 100 simultaneously, sequentially, or in an overlapping fashion. The inclusion of two or more feed inlets according to embodiments of the invention provides various options for the creation of an aerosol product 190. For instance, the presence of two or more feed inlets allows the introduction of two or more different feed streams into an aerosol generating zone 150 of a thermal fogger 100. The ability to aerosolize two or more feed streams and combine the aerosols in a common aerosol generating zone into a single aerosol product 190 may be beneficial.

In some particular embodiments of the invention, the presence of two or more feed inlets allows chemicals or aerosol agents to be introduced into different temperature zones within the aerosol generating zone 150 of a thermal fogger 100. For example, the temperature within the aerosol generating zone 150 closest to the combustion zone 110 is typically higher than the temperature within the aerosol generating zone 150 closest to the exit of the thermal fogger 100. A chemical or aerosol agent which is to be aerosolized within the aerosol generating zone 150 may be introduced at a point in the aerosol generating zone 150 where the temperature is sufficient, or even preferred, for aerosolizing a particular chemical or aerosol agent. For instance, in the application of sprout inhibiting chemicals to stored tubers, it may be desirable to apply aerosols of both CIPC and clove oil to the tubers. CIPC may be aerosolized at a temperature of about 500° F. or more while the clove oil may be aerosolized preferably at a temperature of about 500° F. or less. Introduction of the CIPC into the aerosol generating zone 150 closer to the combustion zone 110 may provide a temperature of 500° F. or greater for aerosolizing the CIPC introduced therein. The clove oil may be introduced further down the length of the aerosol generating zone 150 in a region where the temperature is at or below about 500° F. In this manner, chemicals may be introduced into a portion of the aerosol generating zone 150 of a thermal fogger 100 such that such introduction will aerosolize the introduced chemical. A preferred temperature for aerosolizing liquid CIPC is generally above about 600° F. while that of clove oil is below about 500° F.

The thermal fogger 100 illustrated in FIG. 1 may be a countercurrent-type thermal fogger. While a countercurrent-type thermal fogger is illustrated in FIG. 1 to help illustrate particular embodiments of the invention, it is understood that embodiments of the invention may be incorporated with other types of thermal foggers. For example, a Leco thermal fogger or a suspense thermal fogger, such as those described in U.S. Pat. No. 6,322,002, may be modified or retrofitted according to embodiments of the invention to include two or more inlets for accepting and introducing chemicals or aerosol agents into the aerosol generating zones of such thermal foggers. Other thermal foggers may be similarly modified or retrofitted to include two or more inlets for accepting and introducing chemicals or aerosol agents into an aerosol generating zone of the thermal fogger. The retrofitting or modification of conventional thermal foggers may include the installation of one or more additional feed inlets in an aerosol generating zone of the thermal fogger. In other embodiments, a conventional thermal fogger may be retrofitted with a barrel extension having additional inlets for the introduction of aerosol agents or chemicals. In still other embodiments, conventional thermal foggers may be modified to include new inlet placements within aerosol generating zones of a thermal fogger in addition to barrel extensions having additional inlet positions.

In other embodiments of the invention, a thermal fogger 100 such as that illustrated in FIG. 1, may be equipped with one or more gas inlets (not shown) which allow the introduction of air, gas streams, or other components into the aerosol generating zone 150 of the thermal fogger 100. Any gas introduced into the aerosol generating zone 150 is preferably non-combustible. For example, multiple gas inlets may be configured to allow the introduction of air, such as a pressurized air stream, into the aerosol generating zone 150. The gas inlets may be configured or positioned in a manner so as to cause turbulence or a desired motion or movement within the volumetric space of the aerosol generating zone 150. For instance, the gas inlets may be located circumferentially around the aerosol generating zone 150 and pointed or otherwise directed towards the combustion zone 110 of the thermal fogger such that gas introduced into the gas inlets flows countercurrent to the gases produced in the combustion zone 110 and directed to the aerosol generating zone 150. The intersection of the gas from the gas inlet and the gases or air from the combustion zone 110 may cause a turbulent flow of the combustion gases and air through the aerosol generating zone 150. In other embodiments, the gas inlets may be configured to provide a gas stream into the aerosol generating zone 150 which results in the swirling motion of the aerosols formed in the aerosol generating zone 150. In other embodiments, the gas inlets may be configured to provide a gas stream having a flow pattern consistent with a gas flow from the combustion chamber towards an exit of the aerosol generating zone 150. The turbulent and other gas flows which may be created by introducing gas or air through the gas inlets may be used to mix the aerosols within the aerosol generating zone 150 or to produce a desired flow pattern for an aerosol from a single chemical or multiple chemicals. The configuration, number, and use of gas inlets are not limited to the particular embodiments of the invention discussed herein.

Other methods for disturbing or controlling the pattern of gas, aerosol, and air flow through the aerosol generating zone 150 may also be used with embodiments of the invention. For example, baffles may be included in the aerosol generating zone 150, such as on the walls or suspended within the aerosol generating zone 150, to promote turbulent flow or other forms of fluid and gas flow through the aerosol generating zone 150.

According to other embodiments of the invention, a thermal fogger 200 may include two or more aerosol generating chambers 250A and 250B, as illustrated in FIG. 2. Each of the aerosol generating chambers 250A and 250B may include one or more feed inlets. For example, as illustrated in FIG. 2, a first aerosol generating chamber 250A may include a first feed inlet 271A and a second feed inlet 272A for accepting and delivering to the first aerosol generating chamber 250A different feed streams to be aerosolized. A second aerosol generating chamber 250B may also include multiple feed inlets, such as a first feed inlet 271B, a second feed inlet 272B, and a third feed inlet 273B. While multiple feed inlets are illustrated in FIG. 2, it is understood that each of the aerosol generating chambers 250A and 250B may include one or more than one feed inlet as desired.

The feed inlets may be configured to deliver feed streams to the first aerosol generating zone 250A and the second aerosol generating zone 250B. Feed streams introduced into the first aerosol generating zone 250A may be aerosolized within that zone and directed to the exit of the thermal fogger. Similarly, feed streams introduced into the second aerosol generating zone 250B may be aerosolized within that zone and directed to the exit of the thermal fogger where they combine with the aerosol from the first aerosol generating zone 250A to produce an aerosol product 290. Alternatively, the aerosols produced in each of the aerosol generating zones 250 may exit the thermal fogger 200 separately and may be conveyed to an application site separately. The aerosol product 290 may be applied to a surface or delivered to a spatial volume, such as a potato storage facility.

The thermal fogger 200 may also include one or more adjustable baffles 220 which may be configured to isolate one or more of the aerosol generating zones 250 from the combustion zone 210 or to direct the flow of aerosol within the aerosol generating zones 250. For example, the adjustable baffle 220 illustrated in FIG. 2 may be adjusted to isolate the first aerosol generating zone 250A from the combustion zone 210 such that gases from the combustion zone 210 are not directed into the first aerosol generating zone 250A, thereby stopping the production of aerosol within the first aerosol generating zone 250A. The only aerosol produced by the thermal fogger 200 when the first aerosol generating zone 250A is isolated from the combustion zone 210 would be an aerosol from the second aerosol generating zone 250B. Additional adjustable baffles (not shown) may also be configured to isolate the aerosol generating zones 250 at the product end of the thermal fogger 200. The ability to isolate the aerosol generating zones 250 from the combustion chamber 210 may allow individual aerosol generating zones 250 of the thermal fogger 200 to be used in isolation.

Baffles and gas inlets may also be incorporated with the aerosol generating zones 250 of the thermal fogger 200 illustrated in FIG. 2 to promote a desired flow pattern for the gases, air, and aerosols flowing through the aerosol generating zones 250. For example, gas inlets may provide pressurized gas to the first aerosol generating zone 250A to promote a turbulent flow of aerosol through the first aerosol generating zone 250A while pressurized gas introduced into the second aerosol generating zone 250B may cause a swirling flow of gas, air, or aerosol therein.

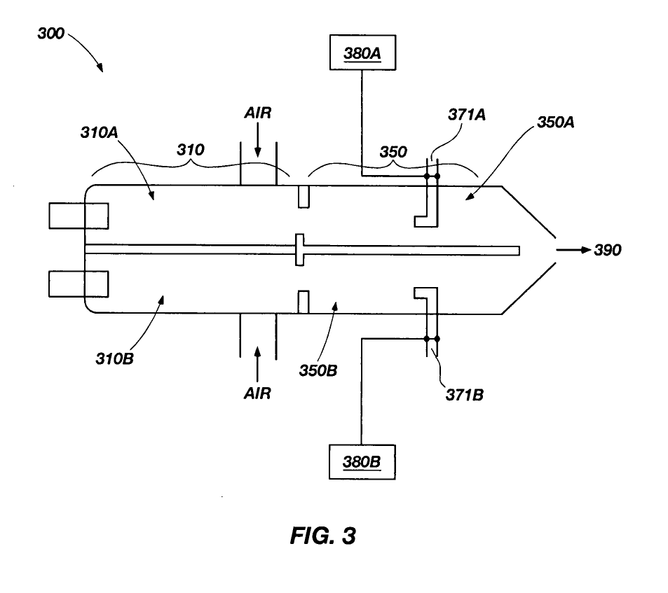

The thermal fogger 200 illustrated in FIG. 2 includes a single combustion chamber 210 which may be capable of providing gases produced by combustion, such as by combustion of a hydrocarbon fuel and heated air to each of the two aerosol generating zones 250A and 250B of the thermal fogger 200. However, in other embodiments of the invention, multiple combustion chambers may be configured with the thermal fogger 300 to provide a combustion chamber 310A and 310B for each of the aerosol generating zones 350A and 350B as illustrated in FIG. 3. Each of the aerosol generating zones 350A and 350B may include one or more feed inlets 371A and 371B as with other embodiments of the invention. Aerosol generated in the first aerosol generating zone 350A may combine with aerosol generated in the second aerosol generating zone 350B to produce an aerosol product 390 which is a combination of aerosols formed from feed streams fed to the multiple feed inlets of the thermal fogger 300.

In other embodiments, the first combustion zone 310A and aerosol generation zone 350A may be operated in conjunction with, simultaneously with, or in sequence with the second combustion zone 310B and second aerosol generation zone 350B. For example, it may be desirable to apply two chemicals in aerosol form to a potato storage facility sequentially. A first chemical may be introduced to the first aerosol generation zone 350A while the first combustion zone 310A is running and the second combustion zone 310B is off. The second combustion zone 310B and second aerosol generation zone 350B may be turned on when the application of the first chemical is complete, at which time the first combustion zone 310A is turned off, ending the production of aerosol of the first chemical from the first aerosol generation zone 350A. In other instances, it may be desirable to overlap the application of two aerosols. In those situations, the first combustion zone 310A and first aerosol generation zone 350A may be operated while the second combustion zone 310B and second aerosol generation zone 350B are shut off. The second combustion zone 310B and second aerosol generating zone 350B may be started and operated while the first combustion zone 310A and the first aerosol generating zone 350A are still in operation. The first combustion zone 310A and first aerosol generating zone 350A could then be turned off, such that the thermal fogger 300 only provides an aerosol from the second aerosol generating zone 350B. In still other embodiments, the first combustion zone 310A, first aerosol generating zone 350A, second combustion zone 310B, and second aerosol generating zone 350B may be operated simultaneously such that both aerosol generating zones 350 produce aerosols to be applied together to a product.

While particular illustrated embodiments of the invention show two aerosol generating zones in a thermal fogger, it is understood that a thermal fogger may include a plurality of aerosol generating zones. In addition, while the illustrated embodiments show the combination of aerosols generated within multiple aerosol generation zones to form a aerosol product, it is understood that the output or exit of each aerosol generation zone may be isolated from the exits of other aerosol generation zones such that aerosols generated in each aerosol generating zone are not mixed or combined within the thermal fogger and may or may not be mixed during application of the aerosols to a product or space.

Particular embodiments of the invention may also include one or more control systems for controlling the amounts of chemicals fed to a thermal fogger of the invention. For example, the thermal fogger 300 illustrated in FIG. 3 may include a first control system 380A for controlling a feed stream to the first inlet 371A of the first aerosol generating zone 350A and a second control system 380B for controlling a feed stream to the first inlet 371B of the second aerosol generating zone 350B. The control systems 380A and 380B may be configured to control various characteristics of the feed streams fed to the feed inlets 371A and 371B. A control system 380 may control the flow rates of a feed stream through a feed inlet 371. A control system may also control other characteristics of a feed stream such as the feed stream temperature, pressure, and composition. For instance, the first control system 380A may be configured to combine two or more chemical feed streams into a single feed stream which may be fed to feed inlet 371A. The control system 380A may also be configured to heat the feed stream to a predetermined temperature which may facilitate the production of aerosol from the feed stream in the aerosol generating zone 350A. Additional controls and configurations for the control systems 380 may be incorporated with embodiments of the invention.

According to other embodiments of the invention, additional ports or inlets may be provided in a thermal fogger. For instance, a port may be provided between two feed inlets to provide hot or cold air or other gases or liquids into the aerosol generating zone between the two feed inlets. The introduction of cold air, for example, may be used to cool the aerosol and combustion gases flowing from the first feed inlet to the second feed inlet such that the temperatures of the combustion gases and aerosol reaching the second feed inlet are lower than those reaching the first feed inlet. For instance, a cold gas introduction downstream of the first feed inlet may permit accurate control of the aerosolizing temperature at the second feed inlet. Additives such as chemicals, air, water, or other solutions may be introduced into the additional ports to alter temperatures within the aerosol generating zones, to provide additional components to an aerosol being generated, or for any other desired reason. Gas inlets and baffles, such as those describe with respect to FIG. 1, may also be incorporated with embodiments of the invention to alter the fluid and gas flow patterns within a thermal fogger.

The various embodiments of the invention may provide improved operating characteristics for thermal foggers and may provide additional latitude in configuring thermal foggers for aerosolizing multiple chemicals in a single thermal fogger unit. For example, positioning of the feed inlets into the aerosol generating zones of the various thermal foggers of the invention may be tailored to provide a desired aerosol, i.e. a wet or dry aerosol or even a vapor for volatile chemicals, such as for applying DMN. The aerosol generating zones in a thermal fogger may exhibit differing temperatures in different areas of the aerosol generating zone. For example, the temperature of the aerosol generating zone nearest the combustion zone is typically higher than the temperature of the aerosol generating zone nearer to exit of the thermal fogger where the aerosol product is expelled from the thermal fogger. In applications where it is desired to aerosolize and combine two chemicals, where a first chemical requires a higher temperature to aerosolize than the second chemical, the first chemical could be introduced closer to the combustion zone through a first feed inlet. The second chemical could then be introduced into the aerosol generating zone in a lower temperature region through a second feed inlet. Thus, the positioning of the feed inlets into the aerosol generating zone may be configured to provide preferred temperatures at which the feed streams entering the feed inlets will be aerosolized.

The combustion chambers of the thermal foggers according to embodiments of the invention may be configured such that the temperatures of the combustion chambers may be controlled. In addition, air or gas inlets into the combustion chambers may be configured to provide a desired combustion rate within the combustion chamber such that desired temperatures may be achieved within the aerosol generation zones to aerosolize the desired chemicals introduced to the aerosol generation zones. Hot air, such as air at temperatures of about 400° F. and above, e.g. about 400° F. to about 750° F., may be provided by electrical heaters or the like if it is desired to eliminate combustion gases from the aerosols. Also, thermal energy from combustion gases may be transferred to hot air via a heat exchanger or other mechanism so that only the heated air enters the aerosol generating zone.

In other embodiments of the invention, the positioning and configuration of the feed inlets may be tailored to introduce feed streams into the aerosol generating zones such that a desired aerosol is produced. For example, it may be desirable to supply an aerosol comprised of two chemicals, DMN and CIPC, to a potato storage facility. Using a thermal fogger according to embodiments of the invention, a CIPC feed stream may be introduced to a first aerosol generating zone of a thermal fogger while a DMN feed stream may be introduced to a second aerosol generating zone of the thermal fogger. Each of the feed streams may be controlled such that the desired amount of chemicals are aerosolized and introduced to the potato storage facility from the aerosol product stream of the thermal fogger. For instance, if a ratio of DMN to CIPC of 1 to 10 was desired, the feed streams of DMN and CIPC could be controlled such that the aerosol product from the thermal fogger delivered an aerosol having the desired ratio of chemicals to the potato storage facility. The CIPC and DMN may also be applied with, mixed with, or otherwise substituted for by other chemicals or additives, such as, but not limited to, clove oil, mint oil, eucalyptus oil, solvents, alkyl naphthalene tuber sprout inhibitors, volatile aromatic oils, or alcohol tuber sprout inhibitors.

In other embodiments of the invention, the thermal foggers may be preferably insulated. For example, the aerosol generating zones, the combustion zones, or both, may include insulation layers to improve heat retention within the thermal foggers and to better regulate temperatures within a thermal fogger.

According to embodiments of the invention, thermal foggers of the invention may be used to provide aerosols that may be applied to agricultural crops or produce, such as to tubers, fruit, or other produce. Thermal foggers according to embodiments of the invention may also be used to apply aerosols to storage facilities for fruits or vegetables, to transport containers for agricultural products, to apply fungicides to a desired surface or volumetric space, to apply aerosols to growing crops, orchards, trees, or other plant varieties. The aerosols may include dry or wet aerosols, or vapors. Chemicals that may be aerosolized according to embodiments of the invention may include, but are not limited to, CIPC, DMN, DIPN, clove oil, mint oil, eucalyptus oil, fungicides, solvents, alkyl naphthalene tuber sprout inhibitors, volatile aromatic oils, or alcohol, especially higher alcohols, tuber sprout inhibitors. These may be applied in various combinations, including simultaneously, sequentially, or in an overlapping fashion.

According to other embodiments of the invention, methods for forming aerosols of multiple chemicals are provided. According to some embodiments of the invention, a first chemical may be introduced to an aerosol generation zone of a thermal fogger through a first feed inlet, wherein the temperature at the first feed inlet in the aerosol generation zone is at a first temperature. A second chemical may be introduced to the aerosol generation zone at a second feed inlet which is at a second temperature within the aerosol generation zone. The first temperature is typically higher than the second temperature. For example, when treating a potato storage facility a first chemical of DMN may be introduced at a first temperature while a second chemical of clove oil may be introduced at a second temperature, wherein the second temperature is lower than the first temperature. The second temperature may be lower than the first temperature by, for example, about 25° F. The first temperature may be, for example, above about 250° F. or more. In some instances a temperature of about 500° F. or more is preferred to evaporate DMN quickly and to apply it as a vapor or gas.

According to other embodiments of the invention, a first chemical may be introduced to a first barrel of a thermal fogger, such as to the first aerosol generating zone 350A of the thermal fogger 300 illustrated in FIG. 3 while a second chemical is introduced to a second barrel of a thermal fogger, such as the second aerosol generating zone 350B of the thermal fogger 300. The first aerosol generating zone 350A and the second aerosol generating zone 350B may be operated at different temperatures. For instance, the first aerosol generating zone 350A may be operated at a temperature higher or lower than that of the second aerosol generating zone 350B. As indicated herein above, the temperatures between the first and second feed inlets may be altered by introducing hot or cold gases between the two inlets. For example, by introducing gases, such as non-combustible gases, at a temperature cooler than the temperature at the first feed inlet, the temperature at the second feed inlet may be lowered. Alternatively, hot gases having a temperature greater than the temperature of gases at the first feed inlet may be introduced between the first and second feed inlets to increase the temperature of the gases at the second feed inlet as compared to that of the first feed inlet.

The following examples demonstrate the operation of thermal foggers according to various embodiments of the invention. Although the examples detail particular chemicals, thermal fogger configurations, and operating temperatures, the examples are not limiting and it is understood that various thermal fogger configurations, various operating temperatures, and various chemicals and aerosol agents may be used with particular embodiments of the invention.

A thermal fogger according to embodiments of the invention may be used to apply sprout inhibiting chemicals to a tuber storage facility. For example, if it would be desirable to apply both CIPC and DMN to a tuber storage facility, a thermal fogger may be configured to accept a CIPC stream in first feed inlet and a DMN stream in second feed inlet. For tuber sprout inhibiting operations, CIPC is generally aerosolized at a temperature of about 500° F. or greater and, in some cases, greater than about 600° F. Therefore, the first feed inlet in the thermal fogger may be positioned within that portion of the aerosol generating zone where the temperature reaches or exceeds at least 500° F. to promote the aerosolization of the CIPC. Similarly, the second feed inlet may be positioned in that portion of the aerosol generation zone where DMN would be efficiently aerosolized. Since DMN may be aerosolized at a temperature of about 400° F. or more, and in some instances preferably at about 500° F. or more, the second feed inlet may be positioned in the aerosol generation zone at a distance further from the combustion zone than the first feed inlet. In this manner, the CIPC and DMN may be aerosolized at different temperatures using the same thermal fogger and same aerosol generating zone. In other embodiments, different aerosol generating zones may be configured to provide the necessary temperature to aerosolize the CIPC and DMN fed to the particular aerosol generating zones.

In other embodiments, it may be desirable to aerosolize other chemicals. For example, aerosolized clove oil may be applied to tubers, fruits, vegetables, or growing plants and trees. Clove oil may be aerosolized at about 600° F. or less and is preferably aerosolized at about 500° F. or less. Thus, an inlet to a thermal fogger for aerosolizing clove oil may be positioned such that the clove oil would be introduced in an aerosol generating zone where the temperature was about 600° F. or less.

Preferred aerosolizing temperatures for various chemicals that may be applied to produce, and especially to tubers or potatoes, included the following:
CIPC—650° F. and above
DMN—500° F. and above
DIPN—500° F. and above
Clove Oil—500° F. and below
Eucalyptus Oil—500° F. and below
Mint Oil—500° F. and below
Nonanol—300° F. and above
Carnone—300° F. and above
   The above referenced temperatures are preferred temperatures and acceptable aerosols may be generated at temperatures that are both higher and lower than the preferred temperatures.

The feed inlets to thermal foggers may be adjusted or positioned such that the feed being introduced to the aerosol generating zone through the feed inlet is introduced at a temperature which is desired for aerosolizing that particular feed.

Having thus described certain currently preferred embodiments of the present invention, it is understood that the invention defined by the appended claims is not to be limited by particular details set forth in the above description, as many apparent variations thereof are contemplated without departing from the spirit or scope thereof as hereinafter claimed.

1. A method of applying a combination of chemicals to crops by thermal aerosol generation comprising:
introducing a first chemical into a thermal aerosol generation zone at a first introduction site at a first aerosol generating temperature to produce an aerosol of said first chemical; and
introducing a second chemical into a thermal aerosol generation zone at a second introduction site to produce an aerosol of said second chemical;
wherein said second introduction site is at a location physically separate from said first introduction site which is at a lower aerosol generating temperature than the temperature at the first introduction site.

2. The method of claim 1, wherein said second introduction site is at a temperature which is at least about 25° F. less than the temperature at said first introduction site.

3. The method of claim 1, wherein said first introduction site is at a temperature above about 250° F.

4. The method of claim 1, wherein said first chemical is CIPC.

5. The method of claim 4, wherein said CIPC comprises a mixture of CIPC with one or more additives selected from the group consisting of solvents, alkyl naphthalene tuber sprout inhibitors, and alcohol tuber sprout inhibitors.

6. The method of claim 4, wherein said CIPC is in a substantially liquid state.

7. The method of claim 4, wherein the aerosol of CIPC is generated at a temperature which is sufficiently elevated to produce an aerosol which is dry.

8. The method of claim 4, wherein said second chemical is a sprout inhibitor for tubers.

9. The method of claim 8, wherein said aerosol of CIPC and an aerosol of said second chemical are substantially cojointly generated.

10. A method of applying a combination of tuber sprout inhibitors by thermal aerosol generation comprising:
generating an aerosol of CIPC by thermal aerosol generation at a first elevated temperature; and
generating an aerosol of at least one additional tuber sprout inhibitor by thermal aerosol generation at a second elevated temperature, said second elevated temperature being substantially below said first elevated temperature, wherein said aerosol of CIPC and said aerosol of additional tuber sprout inhibitor are applied to the same tubers.

11. The method of claim 10, wherein the generation of said aerosols substantially overlaps.

12. The method of claim 10, wherein the aerosol of CIPC is first generated and another sprout inhibitor aerosol is later generated substantially immediately following generation of said CIPC aerosol.

13. The method of claim 10, wherein said aerosol of additional sprout inhibitor precedes generation of said CIPC aerosol.

14. The method of claim 10, wherein said aerosol of CIPC is derived from molten CIPC.

15. The method of claim 10, wherein said additional sprout inhibitor is a volatile aromatic oil.

16. The method of claim 10, wherein said additional sprout inhibitor is an alkyl naphthalene.

17. The method of claim 16, wherein said alkyl naphthalene is DMN.

18. The method of claim 17, wherein said DMN is generated as a vapor.

19. The method of claim 10, wherein said additional tuber sprout inhibitor is a volatile aromatic oil.

20. A thermal aerosol generator comprising:
a heating chamber; and
an aerosol generation zone, wherein the aerosol generation zone comprises multiple inlet ports for introducing at least one liquid to be converted to an aerosol.

21. The thermal aerosol generator of claim 20, with at least two inlet ports, a first inlet port to introduce a first sprout inhibitor into said aerosol generation zone at or near its hottest region, and at least a second inlet port located apart from said first inlet port to introduce a second sprout inhibitor into said aerosol generation zone at or near a region cooler than said hottest region.

22. The thermal aerosol generator of claim 20, having means for introducing a molten sprout inhibitor into at least one of said inlet ports.

23. The thermal aerosol generator of claim 20, having temperature adjustment means to adjust the temperature within said thermal aerosol generator.

24. The thermal aerosol generator of claim 20, wherein said heating chamber has means to introduce a combustible gas and an oxygen-containing gas.

25. The thermal aerosol generator of claim 24, having means to adjust the rate of introduction of said combustible gas and/or means to adjust the rate of introduction of said oxygen-containing gas.

26. The thermal aerosol generator of claim 25, having an aerosol-forming chamber which is spaced apart from said combustion chamber.

27. The thermal aerosol generator of claim 20, having at least one gas introduction port intermediate of at least two of said inlet ports for introduction of a sprout inhibitor.

28. The thermal aerosol generator of claim 20, wherein said heating chamber and said aerosol generating chamber are contained within a single barrel, the barrel being continuous or discontinuous.

29. The thermal aerosol generator of claim 20, wherein at least one inlet port comprises means by which a non-combustible gas may be introduced to the aerosol generating zone.

30. A two-barrel thermal aerosol generator comprising:
a first barrel having a combustion chamber and an aerosol generation chamber;
a second barrel adjacent to said first barrel, said second barrel having a combustion chamber and an aerosol generation chamber;
each barrel having at least one inlet port for introduction of a sprout inhibitor into its aerosol generation chamber; and
temperature control means for controlling the temperature within the aerosol generation chamber of each barrel.

31. The thermal aerosol generator of claim 30, having means for operation of said barrels substantially simultaneously or separately.

32. The thermal aerosol generator of claim 30, wherein said barrels are in contact with one another and substantially contiguous.

33. The thermal aerosol generator of claim 32, wherein said barrels are contained with an insulation enclosure.
